(19) United States
(12) Patent Application Publication
(10) Pub. No.: US 2026/0156021 A1
(43) Pub. Date: Jun. 4, 2026

(54) Control circuit for feed-forward equalizer capable of impedance calibration

(71) Applicant: NOVATEK Microelectronics Corp., Hsin-Chu (TW)

(72) Inventor: Tung-Ming SU, Hsinchu County (TW)

(73) Assignee: NOVATEK Microelectronics Corp., Hsin-Chu (TW)

(21) Appl. No.: 18/964,728

(22) Filed: Dec. 2, 2024

(51) Int. Cl. H04L 25/03

(52) U.S. Cl. CPC H04L 25/03057

(57) ABSTRACT

A control circuit for a feed-forward equalizer (FFE) includes an FFE controller and an impedance control loop. The FFE has a plurality of tap drivers commonly coupled to an output terminal. The FFE controller, which receives a basic current from a current generator, includes a current digital-to-analog converter (DAC) and a current mirror. The current DAC generates a reference current according to the basic current. The current mirror mirrors the reference current to generate at least one first reference voltage, and outputs the at least one first reference voltage to at least one first tap driver among the plurality of tap drivers. The impedance control loop, coupled to the FFE controller, generates a second reference voltage according to the at least one first reference voltage, and outputs the second reference voltage to at least one second tap driver among the plurality of tap drivers.

### BACKGROUND OF THE INVENTION

### 1. Field of the Invention

The present invention relates to a feed-forward equalizer (FFE), and more particularly, to a control circuit for an FFE capable of impedance calibration.

### 2. Description of the Prior Art

The rapid growth of cloud computing, 5G networking, and artificial intelligence has resulted in an explosive bandwidth requirement on communication networks. With the increasing bandwidth requirement, signal transmission is more sensitive to inter-symbol interference (ISI). In order to solve the ISI problem, the transmitter may be implemented with a feed-forward equalizer (FFE) having enough number of slices. Thus, how to deal with the FFE parameter control while satisfying impedance matching for high-speed transmission has become a challenge in this art.

### SUMMARY OF THE INVENTION

It is therefore an objective of the present invention to provide a control circuit for a feed-forward equalizer (FFE), to be applicable to a voltage mode transmitter of a high-speed transmission system.

An embodiment of the present invention discloses a control circuit for an FFE, wherein the FFE has a plurality of tap drivers commonly coupled to an output terminal. The control circuit comprises an FFE controller and an impedance control loop. The FFE controller, which receives a basic current from a current generator, comprises a current digital-to-analog converter (DAC) and a current mirror. The current DAC generates a reference current according to the basic current. The current mirror, coupled to the current DAC, mirrors the reference current to generate at least one first reference voltage, and outputs the at least one first reference voltage to at least one first tap driver among the plurality of tap drivers. The impedance control loop, coupled to the FFE controller, generates a second reference voltage according to the at least one first reference voltage, and outputs the second reference voltage to at least one second tap driver among the plurality of tap drivers.

Another embodiment of the present invention discloses an FFE, which comprises an output circuit and a control circuit. The output circuit comprises a plurality of tap drivers commonly coupled to an output terminal. The control circuit, coupled to the output circuit, comprises an FFE controller and an impedance control loop. The FFE controller, which receives a basic current from a current generator, comprises a current DAC and a current mirror. The current DAC generates a reference current according to the basic current. The current mirror, coupled to the current DAC, mirrors the reference current to generate at least one first reference voltage, and outputs the at least one first reference voltage to at least one first tap driver among the plurality of tap drivers. The impedance control loop, coupled to the FFE controller, generates a second reference voltage according to the at least one first reference voltage, and outputs the second reference voltage to at least one second tap driver among the plurality of tap drivers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an FFE according to an embodiment of the present invention.

FIG. 2 is a schematic diagram of a high-speed transmission system according to an embodiment of the present invention.

FIG. 3 illustrates impedance matching of a transmitter in an impedance viewpoint.

FIG. 4 illustrates impedance matching of a transmitter in a current viewpoint.

FIG. 5 illustrates a detailed implementation of the control circuit according to an embodiment of the present invention.

FIG. 6 illustrates a detailed implementation of the current DAC according to an embodiment of the present invention.

FIG. 7 illustrates a detailed implementation of the control circuit according to an embodiment of the present invention.

### DETAILED DESCRIPTION

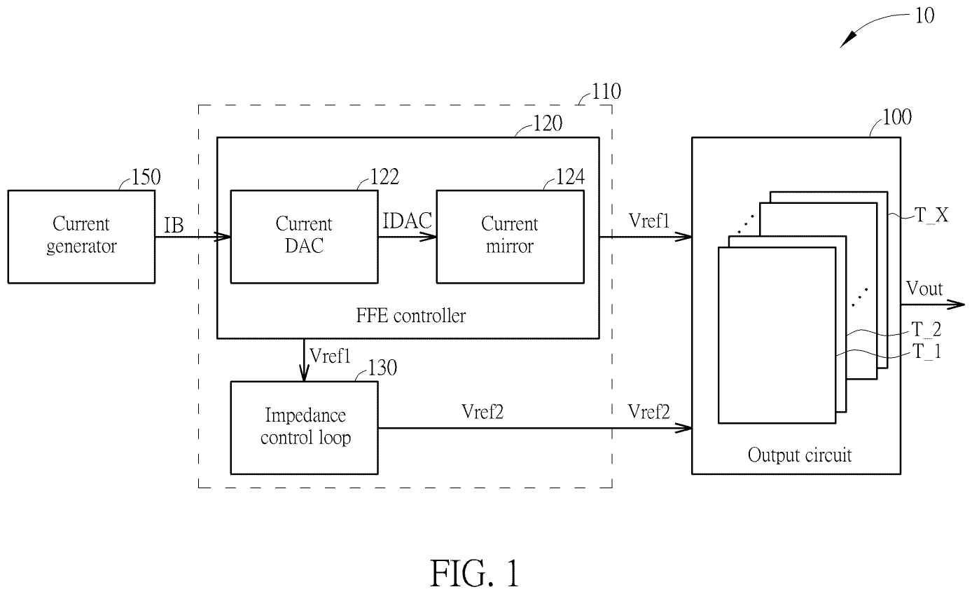

FIG. 1 is a schematic diagram of a feed-forward equalizer (FFE) 10 according to an embodiment of the present invention. The FFE 10 may be implemented in a voltage mode transmitter of a high-speed transmission system, to perform pre-emphasis or de-emphasis on the output signals, so as to reduce or eliminate the influences of noises or cable losses that might interfere with the signals and thereby improve the signal quality.

As shown in FIG. 1, the FFE 10 includes an output circuit 100 and a control circuit 110. The output circuit 100 may serve as an output driver of the voltage mode transmitter, and include a plurality of tap drivers T_1-T_X which are commonly coupled to an output terminal of the transmitter. The output of each tap driver T_1-T_X may be combined to generate an output signal Vout. Each tap driver T_1-T_X may be a driving channel, and may also be referred to as a circuit slice. In general, the tap drivers T_1-T_X include one or more main-tap drivers, one or more pre-tap drivers, and one or more post-tap drivers. The main-tap driver(s) may be configured to output main signals. The pre-tap driver(s) and the post-tap driver(s) may be configured to provide pre-emphasis or de-emphasis to improve the signal quality. In general, the pre-tap driver(s) and post-tap driver(s) are necessary in an FFE implementation, to increase the high-frequency components of the signals to resist the high-frequency attenuations on the transmission channel, so that the signal quality measured at the receiver side may be more satisfactory.

The control circuit 110 is configured to control the operations of the FFE 10, where the FFE coefficient control and impedance control are integrated. In detail, the control circuit 110 includes a FFE controller 120 and an impedance control loop 130. The FFE controller 120 is configured to control the FFE coefficients, and the impedance control loop 130 is configured to control the impedance matching for the transmission channel. A current generator 150, which may be or may not be included in the FFE 10, is also illustrated in FIG. 1 to facilitate the illustrations. The current generator 150 may provide a basic current IB for the FFE controller 120.

The FFE controller 120 may include a current digital-to-analog converter (DAC) 122 and a current mirror 124. After receiving the basic current IB from the current generator 150, the current DAC 122 may generate a reference current IDAC according to the basic current IB. The current mirror 124 may mirror the reference current IDAC to generate at least one first reference voltage Vref1, and output the first reference voltage Vref1 to at least one of the tap drivers T_1-T_X. In various embodiments, the first reference voltage Vref1 may be output to the pre-tap driver(s) and the post-tap driver(s) among the tap drivers T_1-T_X. Based on the pre-tap data and the post-tap data, the FFE controller 120 may generate appropriate reference voltages for the pre-tap driver(s) and post-tap driver(s), to achieve the requested pre-emphasis or de-emphasis effects.

The first reference voltage Vref1 may also be provided for the impedance control loop 130 to perform impedance matching. After receiving the first reference voltage Vref1, the impedance control loop 130 may generate at least one second reference voltage Vref2 according to the first reference voltage Vref1, and output the second reference voltage Vref2 to at least one of the tap drivers T_1-T_X. In various embodiments, the second reference voltage Vref2 may be output to the main-tap driver(s) among the tap drivers T_1-T_X.

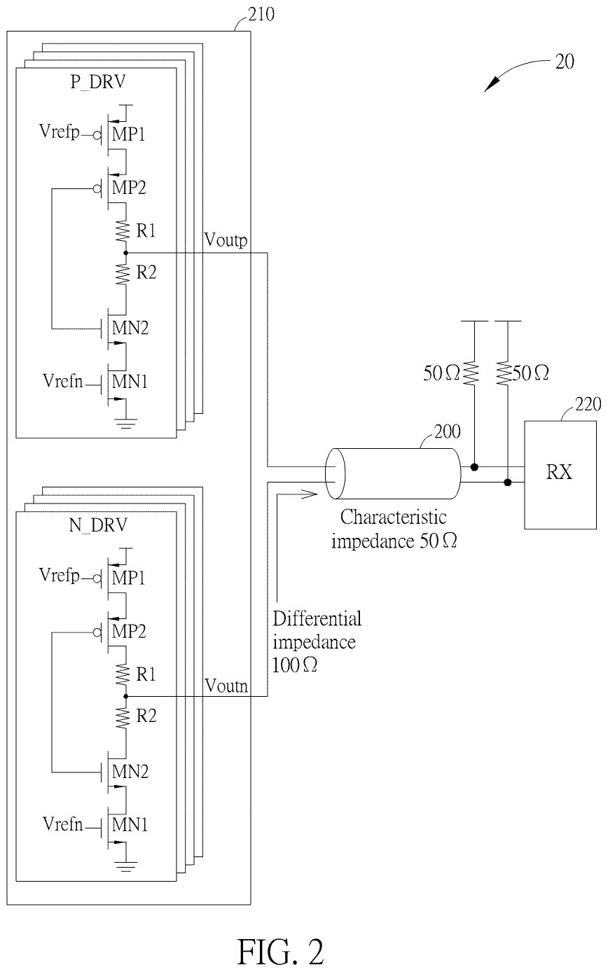

FIG. 2 is a schematic diagram of a high-speed transmission system 20 according to an embodiment of the present invention. The high-speed transmission system 20 includes a transmitter (TX) 210, a receiver (RX) 220, and a transmission channel 200 connected between the transmitter 210 and the receiver 220. The transmission channel 200 may be implemented with a twisted-pair cable, of which the characteristic impedance of the transmission line is equal to 50 ohms (2). The transmission channel 200 may be any type of wired channel capable of high-speed transmission, which includes, but not limited to, the high definition multimedia interface (HDMI) and display port (DP).

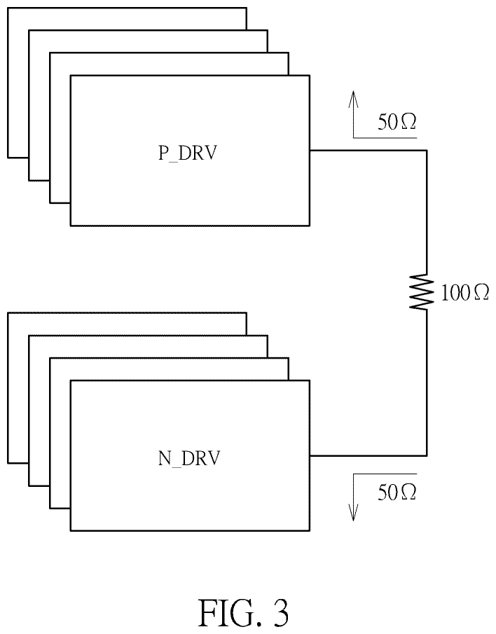

In this embodiment, the transmitter 210 may be a differential transmitter having a pair of output drivers P_DRV and N_DRV, for outputting output signals Voutp and Voutn, respectively. Each of the output drivers P_DRV and N_DRV may be an output circuit of the FFE, such as the output circuit 100 shown in FIG. 1, and include multiple tap drivers, which may include one or more pre-tap drivers, one or more post-tap drivers, and one or more main-tap drivers. Due to the differential structure, the differential impedance faced by the transmitter 210 will be equal to 100Ω. This is equivalent to the situation that the output drivers P_DRV and N_DRV are respectively coupled to two terminals of a resistive load equal to 100Ω, as shown in FIG. 3. In order to achieve impedance matching, the output drivers P_DRV and N_DRV should be well designed so that the output impedance of P_DRV is substantially equal to 50Ω and the output impedance of N_DRV is substantially equal to 50Ω.

It should be noted that, in a high-speed transmission system, impedance matching is a basic requirement. The transmitter is requested to have output impedance substantially equal to 50Ω, or approximate to 50Ω with a tolerable error; otherwise, the output signal may be reflected unwantedly to degrade the signal quality.

As shown in FIG. 2, in the output drivers P_DRV and N_DRV, each tap driver may be composed of two PMOS transistors MP1 and MP2, two NMOS transistors MN1 and MN2, and two resistors R1 and R2. The transistors MP1 and MN1 may receive reference voltages Vrefp and Vrefn, respectively, to generate desired output impedance to match the characteristic impedance of the transmission channel 200. Based on the FFE structure of the transmitter 210, each of the output drivers P_DRV and N_DRV is composed of multiple tap drivers; hence, the output impedance of each output driver P_DRV or N_DRV is generated from the combination of output impedances of these tap drivers connected in parallel. In other words, the output impedance of each tap driver should be well designed, to achieve the target impedance 50Ω for each of the output drivers P_DRV and N_DRV when these tap drivers are connected in parallel.

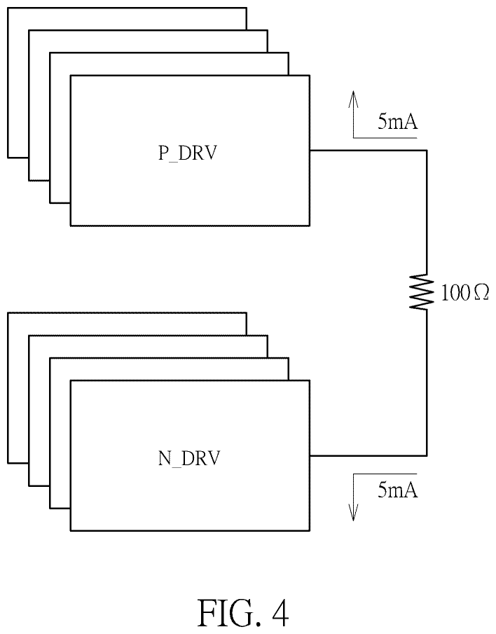

Instead of the above impedance viewpoint, the present invention applies a current viewpoint to deal with the impedance matching issue, as shown in FIG. 4. When the output impedances of the output drivers P_DRV and N_DRV are perfectly matching to have the value 50Ω, the overall impedance from the power supply terminal of one output driver (e.g., P_DRV) to the ground terminal of another output driver (e.g., N_DRV) is equal to 200Ω. Assuming that the power voltage VCC supplied to the output drivers P_DRV and N_DRV is 1V, the overall current flowing through the channel formed by the output drivers P_DRV and N_DRV and the 100Ω resistive load will be equal to 5 mA. This 5 mA current may be allocated to each tap driver of the output drivers P_DRV and N_DRV. In such a situation, the strength of pre-emphasis/de-emphasis may be adjusted by tuning the currents flowing through the pre-tap driver(s) and post-tap driver(s). The current for the main-tap driver(s) can thereby be controlled, to let the summation of the currents of all tap drivers to be equal to 5 mA.

Referring to FIG. 2 along with FIG. 4, the current flowing to a tap driver may be controlled by adjusting the reference voltage Vrefp or Vrefn. As for the pre-tap driver(s) and post-tap driver(s), the reference voltage Vrefp or Vrefn may be designed to have an appropriate value to achieve requested pre-emphasis/de-emphasis effects. Accordingly, the reference voltage Vrefp or Vrefn for the main-tap driver(s) may further be designed to achieve that the overall current flowing through each of the output drivers P_DRV and N_DRV is equal to 5 mA.

In a prior work, the impedance matching is performed in consideration of the impedance viewpoint. Based on the pre-tap data and post-tap data, the FFE control circuit may select desired output impedance for the pre-tap driver and the post-tap driver from a resistor array. The reference voltages Vrefp and Vrefn for the pre-tap driver and the post-tap driver can thereby be generated by using an operational amplifier (op-amp) to lock the output impedance to a target level. Based on the output impedance of the pre-tap driver and the post-tap driver, the control circuit may determine the output impedance of the main-tap driver, in order to control the overall output impedance to reach 50Ω. The control circuit then determines the reference voltages Vrefp and Vrefn for the main-tap driver accordingly, to make the overall output impedance of the output circuit (i.e., the parallel impedances of the tap drivers) equal to 50Ω. Note that the prior FFE control circuit is deployed with a resistor array switchable according to the pre-tap or post-tap data, and the resistor array should have a considerable area to realize necessary pre-emphasis/de-emphasis functions. In addition, this FFE control circuit uses many op-amps to lock the reference voltages Vrefp and Vrefn, where the op-amps usually consume a great amount of power.

Therefore, the present invention provides a novel control circuit for the FFE and high-speed transmitter, where the control circuit controls the impedance matching in consideration of the current viewpoint. For example, as shown in FIG. 1, the FFE controller 120 may be implemented by using a current DAC 122 with a current mirror 124 to generate requested currents for the tap drivers. Therefore, there is no need to deploy a large resistor array, and the usage of op-amps may be reduced, so as to reduce the circuit areas and power consumptions.

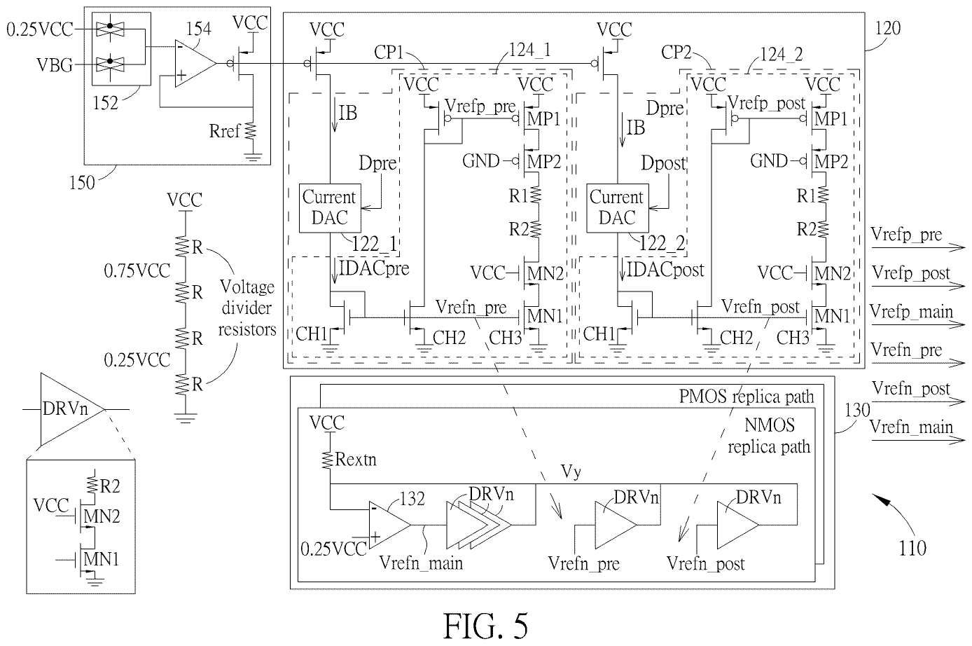

FIG. 5 illustrates a detailed implementation of the control circuit 110 according to an embodiment of the present invention. The control circuit 110 is configured to output reference voltages to an output circuit (such as the output circuit 100 shown in FIG. 1), which is omitted in FIG. 5 for simplicity. In an embodiment, the output circuit includes three main-tap drivers, one pre-tap driver and one post-tap driver. The control circuit 110 may provide reference voltages Vrefp_main and Vrefn_main for the main-tap drivers, provide reference voltages Vrefp_pre and Vrefn_pre for the pre-tap driver, and provide reference voltages Vrefp_post and Vrefn_post for the post-tap driver. The P-type reference voltages Vrefp_main, Vrefp_pre and Vrefp_post are provided to a PMOS transistor of the corresponding tap driver, and may be implemented as the reference voltage Vrefp output to the transistor MP1 as shown in FIG. 2. The N-type reference voltages Vrefn_main, Vrefn_pre and Vrefn_post are provided to an NMOS transistor of the corresponding tap driver, and may be implemented as the reference voltage Vrefn output to the transistor MN1 as shown in FIG. 2.

Note that in another embodiment, the output circuit may include multiple pre-tap drivers and/or multiple post-tap drivers, and/or may include any number of main-tap drivers. For example, in order to achieve a higher transmission speed, there may be more main-tap drivers included in the output circuit. The number of each type of tap drivers (or slices) included in the output circuit should not serve as a limitation of the present invention.

The FFE controller 120 in the control circuit 110 is configured to generate the reference voltages Vrefp_pre and Vrefn_pre for the pre-tap driver, and generate the reference voltages Vrefp_post and Vrefn_post for the post-tap driver. In order to achieve the required pre-emphasis/de-emphasis effects for the output signals, the FFE controller 120 may control the values of these reference voltages.

Based on the values of the reference voltages Vrefp_pre, Vrefn_pre, Vrefp_post and Vrefn_post, the impedance control loop 130 in the control circuit 110 is configured to generate the reference voltages Vrefp_main and Vrefn_main for the main-tap drivers. The values of the reference voltages Vrefp_main and Vrefn_main may be well adjusted to control the overall current flowing through the tap drivers, so as to satisfy the impedance matching requirements.

In detail, the FFE controller 120 includes a pre-tap controller CP1 and a post-tap controller CP2. The pre-tap controller CP1 includes a current DAC 122_1 and a current mirror 124_1, and the post-tap controller CP2 includes a current DAC 122_2 and a current mirror 124_2. In general, the pre-tap controller CP1 and the post-tap controller CP2 have the same structure, and the pre-tap controller CP1 is taken as an example for detailed illustrations hereinafter.

In the pre-tap controller CP1, the current DAC 122_1 may receive the basic current IB and also receive the control of a pre-tap data Dpre, which is associated with the pre-emphasis or de-emphasis strength requirements. The pre-tap data Dpre may be used to determine the value of the reference current IDACpre output by the current DAC 122_1.

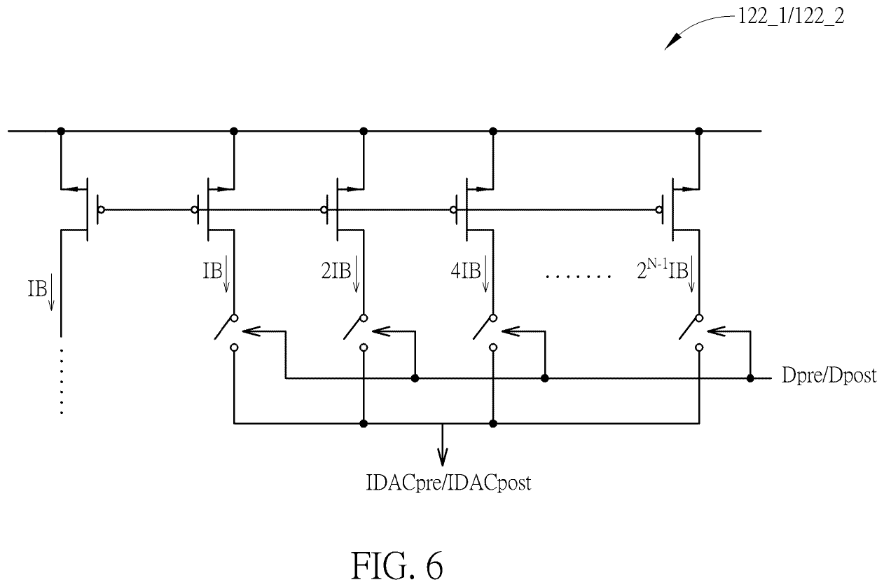

FIG. 6 illustrates a detailed implementation of the current DAC 122_1 according to an embodiment of the present invention. As shown in FIG. 6, the current DAC 122_1 may include N output channels with different current weightings. The pre-tap data Dpre may be an N-bit control data respectively output to the switch of the N output channels, to control the conduction of each output channel. The currents of the conducted channels are summed up to generate the reference current IDACpre to be output by the current DAC 122_1. In this embodiment, the reference current IDACpre may be a multiple k of the basic current IB, where the multiple k may be determined from the pre-tap data Dpre. The related formula is described as follows:

$${IDAC}_{pre} = k \times IB .$$

The current mirror 124_1 includes an input channel CH1, a mirror channel CH2 and a replica channel CH3. The replica channel CH3 may be a replica of a corresponding tap driver, and thus include two PMOS transistors MP1 and MP2, two NMOS transistors MN1 and MN2, and two resistors R1 and R2, where the symbols are taken from the corresponding elements of the tap driver. To emulate the environment of the tap driver for impedance matching, the high-side PMOS transistors and the low-side NMOS transistors in the replica channel CH3 should both be fully conducted; hence, the gate terminal of the NMOS transistor MN2 may receive a power voltage VCC and the gate terminal of the PMOS transistor MP2 may receive a ground voltage GND. The input channel CH1 is coupled to the replica channel CH3 through the gate terminal of the NMOS transistor MN1, which is a node on which the reference voltage Vrefn_pre is generated. Based on the reference current IDACpre having a target value expected to flow through the pre-tap driver, the reference voltage Vrefn_pre may be exactly at its target value to be provided for the transistor MN1 of the pre-tap driver. The mirror channel CH2 is coupled to the replica channel CH3 through the gate terminal of the PMOS transistor MP1, which is a node on which the reference voltage Vrefp_pre is generated. Similarly, based on the reference current IDACpre having a target value expected to flow through the pre-tap driver, the reference voltage Vrefp_pre may be exactly at its target value to be provided for the transistor MP1 of the pre-tap driver.

In a similar manner, the current DAC 122_2 and the current mirror 124_2 of the post-tap controller CP2 may cooperate to generate the reference voltages Vrefp_post and Vrefn_post for the post-tap driver. More specifically, the current DAC 122_2 may generate a reference current IDACpost, of which the value is controlled by receiving a post-tap data Dpost. The current DAC 122_2 may also have the circuit structure shown in FIG. 6 to generate the required reference current IDACpost. The current mirror 124_2 may also have the structure identical to the current mirror 124_1. By mirroring the reference current IDACpost, the current mirror 124_2 may generate the reference voltages Vrefp_post and Vrefn_post.

The reference voltages Vrefp_pre, Vrefn_pre, Vrefp_post and Vrefn_post generated by the FFE controller 120 are provided for the impedance control loop 130, allowing the impedance control loop 130 to perform impedance matching and generate the reference voltages Vrefp_main and Vrefn_main for the main-tap drivers. In various embodiments, the impedance control loop 130 may determine the values of the reference voltages Vrefp_main and Vrefn_main according to the values of the reference voltages Vrefp_pre, Vrefn_pre, Vrefp_post and Vrefn_post. As mentioned above, the FFE controller 120 may determine the reference voltages Vrefp_pre, Vrefn_pre, Vrefp_post and Vrefn_post for the pre-tap driver and the post-tap driver, thereby determining the currents flowing through the pre-tap driver and the post-tap driver. From the current viewpoint of impedance matching, the impedance control loop 130 may control the current flowing through the main-tap drivers, so that the overall current of the output circuit reaches a level corresponding to the characteristic impedance 50Ω. For example, the overall current will be 5 mA if the power voltage VCC is equal to 1V. To reach the required overall current, the impedance control loop 130 may generate the reference voltages Vrefp_main and Vrefn_main to be output to the main-tap drivers.

In detail, the impedance control loop 130 includes an NMOS replica path and a PMOS replica path, where FIG. 5 shows the structure of the NMOS replica path. As shown in FIG. 5, the NMOS replica path includes an op-amp 132, an external resistor Rextn and a plurality of NMOS replica drivers DRVn. The NMOS replica drivers DRVn are configured to emulate the NMOS path of the tap drivers included in the output circuit. More specifically, each NMOS replica driver DRVn may be a replica of the NMOS path of one tap driver, which includes two NMOS transistors MN1 and MN2 and one resistor R2. In addition, since there are three main-tap drivers, one pre-tap driver and one post-tap driver included in the output circuit, the NMOS replica path may include three NMOS replica drivers DRVn for emulating the main-tap drivers, one NMOS replica driver DRVn for emulating the pre-tap driver, and one NMOS replica driver DRVn for emulating the post-tap driver. The NMOS replica drivers DRVn for emulating the pre-tap driver and the post-tap driver may obtain the reference voltages Vrefn_pre and Vrefn_post, respectively, which are received from the FFE controller 120. With the appropriate replica structure in the NMOS replica path, the reference voltage Vrefn_main capable of generating the required output current may be obtained at the NMOS replica drivers DRVn corresponding to the main-tap drivers; that is, the reference voltage Vrefn_main is obtained at the gate terminal of the transistor MN1 of these NMOS replica drivers DRVn.

In the NMOS replica path, in addition to allocating the number of NMOS replica drivers DRVn identical to the number of tap drivers, these NMOS replica drivers DRVn, the external resistor Rextn and the op-amp 132 may be designed appropriately to emulate the environment of the output circuit when the NMOS path is conducted. In detail, the transistor MN2 in each NMOS replica driver DRVn may receive the power voltage VCC to ensure that the NMOS path is conducted. The value of the external resistor Rextn and the input voltage of the op-amp 132 are well designed to achieve the required output impedance 50Ω. In an exemplary embodiment, the op-amp 132 may receive the voltage 0.25VCC, while the external resistor Rextn is equal to 150Ω, so as to realize the output impedance 50Ω. The voltage 0.25VCC may be easily obtained by deploying several voltage divider resistors R between the power supply terminal and ground terminal, as shown in FIG. 5.

The operation principle of the NMOS replica path is described as follows. Since an input terminal of the op-amp 132 receives the voltage 0.25VCC, due to the virtual short-circuit feature of the op-amp 132, its another input terminal (i.e., the node Vy) will also reach 0.25VCC. A current path will form in the NMOS replica path, where a current from the power supply terminal may flow to the node Vy through the external resistor Rextn, and then to the ground terminal through the NMOS replica drivers DRVn connected in parallel. The power voltage at the power supply terminal is VCC, and the voltage at the node Vy equals 0.25VCC. Under the relations of the voltage values, since the external resistor Rextn is set to 150Ω, the impedance between the node Vy to the ground terminal will be 50Ω, which means that the overall impedance of the NMOS replica drivers DRVn connected in parallel will be equal to 50Ω.

From the current viewpoint, in the current path formed in the NMOS replica path, the current may be equal to the cross-voltage of the external resistor Rextn divided by its resistance value, i.e., (VCC−0.25VCC)/Rextn. If the power voltage VCC is 1V and the external resistor Rextn is 150Ω, the current will be equal to 5 mA, which may satisfy the impedance matching requirement as shown in FIG. 4.

Therefore, the impedance matching in the NMOS path may be achieved under the balance of the circuitry in the NMOS replica path of the impedance control loop 130. The input voltage of the op-amp 132 and the external resistor Rextn are predetermined to have appropriate values, so as to achieve the output impedance and current with impedance matching. The reference voltages Vrefn_pre and Vrefn_post for the NMOS replica drivers DRVn corresponding to the pre-tap driver and the post-tap driver are known values obtained from the FFE controller 120. As a result, the reference voltage Vrefn_main for the main-tap drivers may be obtained in the corresponding NMOS replica drivers DRVn.

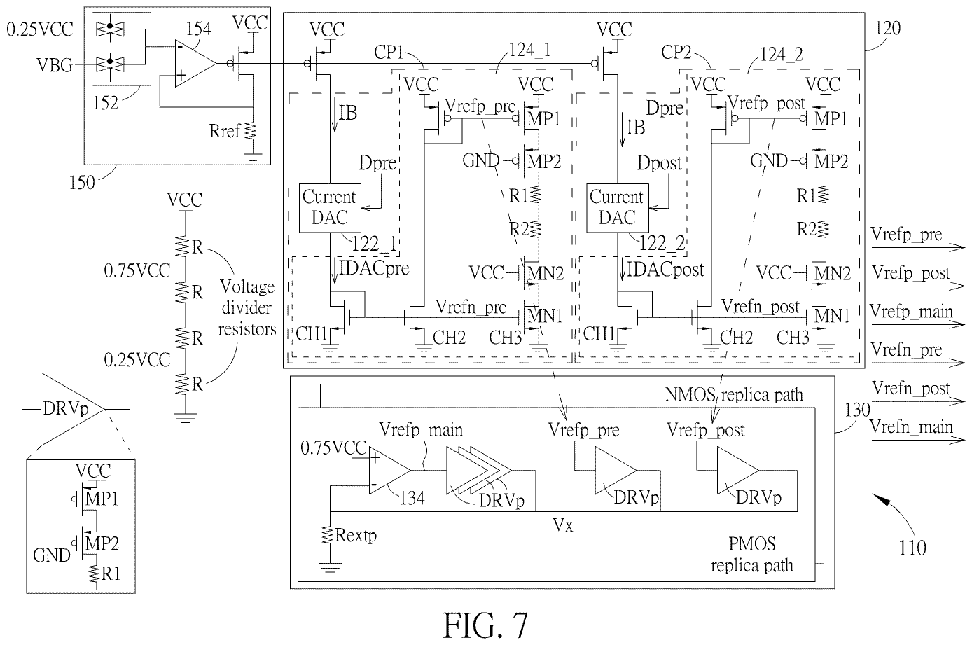

FIG. 7 also illustrates a detailed implementation of the control circuit 110 according to an embodiment of the present invention, where an implementation of the PMOS replica path in the impedance control loop 130 is shown. As shown in FIG. 7, the PMOS replica path includes an op-amp 134, an external resistor Rextp and a plurality of PMOS replica drivers DRVp. The PMOS replica drivers DRVp are configured to emulate the PMOS path of the tap drivers included in the output circuit. More specifically, each PMOS replica driver DRVp may be a replica of the PMOS path of one tap driver, which includes two PMOS transistors MP1 and MP2 and one resistor R1. Similarly, since there are three main-tap drivers, one pre-tap driver and one post-tap driver included in the output circuit, the PMOS replica path may include three PMOS replica drivers DRVp for emulating the main-tap drivers, one PMOS replica driver DRVp for emulating the pre-tap driver, and one PMOS replica driver DRVp for emulating the post-tap driver. The PMOS replica drivers DRVp for emulating the pre-tap driver and the post-tap driver may obtain the reference voltages Vrefp_pre and Vrefp_post, respectively, which are received from the FFE controller 120. With the appropriate replica structure in the PMOS replica path, the reference voltage Vrefp_main capable of generating the required output current may be obtained at the PMOS replica drivers DRVp corresponding to the main-tap drivers; that is, the reference voltage Vrefp_main is obtained at the gate terminal of the transistor MP1 of these PMOS replica drivers DRVp.

In the PMOS replica path, in addition to allocating the number of PMOS replica drivers DRVp identical to the number of tap drivers, these PMOS replica drivers DRVp, the external resistor Rextp and the op-amp 134 may be designed appropriately to emulate the environment of the output circuit when the PMOS path is conducted. In detail, the transistor MP2 in each PMOS replica driver DRVp may receive the ground voltage GND to ensure that the PMOS path is conducted. The value of the external resistor Rextp and the input voltage of the op-amp 134 are well designed to achieve the required output impedance 50Ω. In an exemplary embodiment, the op-amp 134 may receive the voltage 0.75VCC, while the external resistor Rextp is equal to 150Ω, so as to realize the output impedance 50Ω. The voltage 0.75VCC may also be easily obtained by using the voltage divider resistors R deployed between the power supply terminal and ground terminal, as shown in FIG. 7.

The operation principle of the PMOS replica path is described as follows. Since an input terminal of the op-amp 134 receives the voltage 0.75VCC, due to the virtual short-circuit feature of the op-amp 134, its another input terminal (i.e., the node Vx) will also reach 0.75VCC. A current path will form in the PMOS replica path, where a current from the power supply terminal may flow to the node Vx through the PMOS replica drivers DRVp connected in parallel, and then to the ground terminal through the external resistor Rextp. The power voltage at the power supply terminal is VCC, and the voltage at the node Vx equals 0.75VCC. Under the relations of the voltage values, since the external resistor Rextp is set to 150Ω, the impedance between the power supply terminal to the node Vx will be 50Ω, which means that the overall impedance of the PMOS replica drivers DRVp connected in parallel will be equal to 50Ω.

From the current viewpoint, in the current path formed in the PMOS replica path, the current may be equal to the cross-voltage of the external resistor Rextp divided by its resistance value, i.e., 0.75VCC/Rextp. If the power voltage VCC is 1V and the external resistor Rextp is 150Ω, the current will be equal to 5 mA, which may satisfy the impedance matching requirement as shown in FIG. 4.

Therefore, the impedance matching in the PMOS path may be achieved under the balance of the circuitry in the PMOS replica path of the impedance control loop 130. The input voltage of the op-amp 134 and the external resistor Rextp are predetermined to have appropriate values, so as to achieve the output impedance and current with impedance matching. The reference voltages Vrefp_pre and Vrefp_post for the PMOS replica drivers DRVp corresponding to the pre-tap driver and the post-tap driver are known values obtained from the FFE controller 120. As a result, the reference voltage Vrefp_main for the main-tap drivers may be obtained in the corresponding PMOS replica drivers DRVp.

Note that the value of the external resistor Rextn or Rextp included in the impedance control loop 130 is merely an example. As long as the replica path can reach the required output impedance 50Ω, the external resistor Rextn or Rextp may be designed to have any appropriate value. For example, in another embodiment, the op-amp 132 or 134 may receive an input voltage equal to 0.5VCC. In such a situation, the external resistor Rextn or Rextp may be set to 50Ω.

FIG. 5 and FIG. 7 also show an exemplary implementation of the current generator 150, which includes a selector 152, an op-amp 154 and a reference resistor Rref. The current generator 150 is configured to generate the basic current IB, which is requested to have a high accuracy. With the structure of the current generator 150, the basic current IB may be equal to an input voltage divided by the reference resistor Rref. In an embodiment, the reference resistor Rref may be an external resistor having an accurate resistance value.

The input voltage of the current generator 150 may be selected from a bandgap voltage VBG or a divided voltage (e.g., through the selector 152). The bandgap voltage VBG is a constant voltage immune to PVT (process, voltage, temperature) variations. Therefore, by receiving the bandgap voltage VBG, the basic current IB generated by the current generator 150 may have a precise value that would not be affected by environmental variations. The divided voltage may be generated by using the power voltage VCC with voltage divider resistors R. More specifically, the divided voltage is equal to the power voltage VCC divided by a specific ratio determined based on the voltage divider resistors R, as shown in FIG. 5 and FIG. 7. For example, the current generator 150 may receive the voltage 0.25VCC, and then use the voltage 0.25VCC with the reference resistor Rref to generate the basic current IB. By receiving the divided voltage, the variations of the basic current IB will follow the variations of the power voltage VCC; that is, the basic current IB and the power voltage VCC will have the same degree of variations. The synchronous variations cause that the control circuit may still generate the required current for impedance matching regardless of the variations of the power voltage VCC.

The structure of the control circuit for FFE provided in the present invention may achieve various benefits. In an embodiment, the control circuit may perform equalization and calibration continuously. The continuous calibration will protect against the PVT variations at every instant. The pre-emphasis/de-emphasis strength of the FFE controller will not be easily affected by the PVT variations, and thus the number of tap drivers (i.e., slices) may be fixed under different environmental variations. In addition, since the FFE controller of the present invention uses the current DACs and current mirrors to replace the large-size resistor array and power-consuming op-amp in the prior work, the performance on circuit size and power consumption may be improved.

Note that the present invention aims at providing a control circuit for an FFE applicable to a voltage mode transmitter. Those skilled in the art may make modifications and alterations accordingly. For example, the control circuit of the present invention is applicable to any signal modulation techniques, including but not limited to non-return-to-zero (NRZ) and 4-level pulse amplitude modulation (PAM4). In the above embodiments, the structure of the control circuit may be applied to NRZ. In another embodiment, it is possible to use more current DACs and more current mirrors having the same structure to realize the FFE control in a PAM4 signaling system.

In addition, the implementations of the control circuit shown in FIGS. 5-7 are merely exemplary embodiments of the present invention. For example, in the FFE controller 120, the current DAC 122 is configured to generate a controllable current based on the pre-tap data or post-tap data. In another embodiment, the current DAC 122 may be replaced by a variable current source capable of generating a variable and controllable output current. Further, it should be noted that the external resistor Rextn/Rextp used in the impedance control loop 130 and/or the reference resistor Rref used in the current generator 150 is preferably an off-chip resistor, which usually has a precise value, and thus accurate calibration results for pre-emphasis/de-emphasis and impedance matching may be achieved. In another embodiment, if there is an on-chip resistor (or referred to as internal resistor) with sufficient accuracy or preciseness, this on-chip resistor may be applied to replace the off-chip resistor, in order to reduce the circuit cost. Also note that the structure of each tap driver is merely an example. In another embodiment, there may be more or less transistors and/or more or less resistors included in a tap driver, and/or these circuit elements may be connected in another way. In such a situation, the replica channel and replica path implemented in the control circuit should be modified accordingly.

To sum up, the present invention provides a novel control circuit for an FFE applicable to a voltage mode transmitter of a high-speed transmission system. The voltage mode transmitter may include multiple tap drivers in its output circuit, including one or more pre-tap drivers, one or more post-tap drivers, and one or more main-tap drivers. The main-tap driver is the main driver cell of the transmitter. The pre-tap driver and the post-tap driver are configured to perform pre-emphasis or de-emphasis of the FFE. The control circuit has both the FFE coefficient control and impedance matching functions. In various embodiments, the control circuit is composed of an FFE controller and an impedance control loop. The FFE controller includes a current DAC and a current mirror, which apply a reference current to a replica channel to determine the reference current used for the pre-tap driver and the post-tap driver, thereby generating the reference voltages for the pre-tap driver and the post-tap driver. Based on the reference voltages for the pre-tap driver and the post-tap driver, the impedance control loop may emulate the NMOS path and the PMOS path of the output circuit to reach an overall current corresponding to the characteristic impedance of the transmission line, thereby generating the reference voltages for the main-tap driver. All the reference voltages may be provided to the tap drivers, to realize the pre-emphasis/de-emphasis effects and also achieve impedance matching.

Those skilled in the art will readily observe that numerous modifications and alterations of the device and method may be made while retaining the teachings of the invention. Accordingly, the above disclosure should be construed as limited only by the metes and bounds of the appended claims.

1. A control circuit for a feed-forward equalizer (FFE), the FFE having a plurality of tap drivers commonly coupled to an output terminal, the control circuit comprising:
an FFE controller to receive a basic current from a current generator, comprising:
a current digital-to-analog converter (DAC) to generate a reference current according to the basic current; and
a current mirror, coupled to the current DAC, to mirror the reference current to generate at least one first reference voltage, and output the at least one first reference voltage to at least one first tap driver among the plurality of tap drivers; and
an impedance control loop, coupled to the FFE controller, to generate a second reference voltage according to the at least one first reference voltage, and output the second reference voltage to at least one second tap driver among the plurality of tap drivers.

2. The control circuit of claim 1, wherein the current generator generates the basic current by using a bandgap voltage, or using a power voltage with a voltage divider resistor.

3. The control circuit of claim 1, wherein the current mirror comprises:
a replica channel;
an input channel, coupled to the replica channel through a first node having one of the at least one first reference voltage; and
a mirror channel, coupled to the replica channel through a second node having another one of the at least one first reference voltage.

4. The control circuit of claim 3, wherein the replica channel is a replica of one of the at least one first tap driver.

5. The control circuit of claim 1, wherein the current DAC receives a control data, which determines a value of the reference current.

6. The control circuit of claim 1, wherein the plurality of tap drivers comprise a pre-tap driver, a post-tap driver and a main-tap driver.

7. The control circuit of claim 6, wherein the at least one first tap driver comprises the pre-tap driver and the post-tap driver, and the at least one second tap driver comprises the main-tap driver.

8. The control circuit of claim 1, wherein the FFE controller determines the at least one first reference voltage for pre-emphasis or de-emphasis of the FFE.

9. The control circuit of claim 1, wherein the impedance control loop determines the at least one second reference voltage according to the at least one first reference voltage, to control the plurality of tap drivers to generate a current corresponding to a characteristic impedance.

10. A feed-forward equalizer (FFE), comprising:
an output circuit, comprising a plurality of tap drivers commonly coupled to an output terminal; and
a control circuit, coupled to the output circuit, comprising:
an FFE controller to receive a basic current from a current generator, comprising:
a current digital-to-analog converter (DAC) to generate a reference current according to the basic current; and
a current mirror, coupled to the current DAC, to mirror the reference current to generate at least one first reference voltage, and output the at least one first reference voltage to at least one first tap driver among the plurality of tap drivers; and
an impedance control loop, coupled to the FFE controller, to generate a second reference voltage according to the at least one first reference voltage, and output the second reference voltage to at least one second tap driver among the plurality of tap drivers.
